(19) United States
(12) Patent Application Publication
(10) Pub. No.: US 2009/0180782 A1
(43) Pub. Date: Jul. 16, 2009

(54) APPARATUS, SYSTEM, COMPUTER PROGRAM, AND METHOD FOR PROVIDING A MULTIMEDIA-OVER-COAX-ALLIANCE NETWORK IN CONJUNCTION WITH AN OPTICAL NETWORK

(75) Inventors: MARC R. BERNARD, Miramar, FL (US); Thomas E. Conklin, Leesburg, VA (US); Douglas A. Atkinson, Ashbrun, VA (US); David H. Liu, Herndon, VA (US)

Correspondence Address: FITZPATRICK CELLA HARPER & SCINTO, 30 ROCKEFELLER PLAZA, NEW YORK, NY, 10112, US

(73) Assignee: TELLABS VIENNA, INC., Naperville, IL (US)

(21) Appl. No.: 12/013,696

(22) Filed: Jan. 14, 2008

(51) Int. Cl. H04B 10/00

(52) U.S. Cl. 398/140

(57) ABSTRACT

An apparatus, system, computer program, and method for providing a Multimedia over Coax Alliance (MoCA) (or other multimedia-over-coaxial cable technology) network in conjunction with an optical network. In example embodiments, MoCA data is communicated between network nodes in an optical signal. In other example embodiments, MoCA data, or other data, is transmitted in optical frequencies above 860 MHz.

### BACKGROUND

1. Field

Example aspects of the present invention relate generally to an apparatus, a system, computer program, and a method for providing a Multimedia over Coax Alliance (MoCA) (or other multimedia-over-coaxial cable technology) network in conjunction with an optical network. Further example aspects of the present invention relate to a method of sending MoCA data, or other types of data, over an optical network using specific frequency bands of an optical signal.

2. Related Art

Many homes and businesses have coaxial cable already installed in the home infrastructure. For example, many homes have existing coaxial cable in one or more primary entertainment consumption locations such as family rooms, media rooms and master bedrooms. MoCA technology enables homeowners to utilize such a coaxial cable infrastructure to create a MoCA network that delivers entertainment and information programming, such as digital video, music, games and images, with high quality of service.

More specifically, a MoCA network may be established between MoCA devices, or, more generally, between MoCA nodes. MoCA specifications result in data being transmitted from one MoCA node to another MoCA node on a coaxial cable at speeds well exceeding 100 Mbits/s. Thus, MoCA technology allows for applications such as high-definition television (HDTV), gaming, internet, digital video recording (DVR), and other entertainment to work efficiently on an existing coaxial cable without any additional infrastructure.

A MoCA network typically utilizes a node acting as the MoCA network coordinator. That is, the MoCA network typically utilizes a node that negotiates and configures channels with the other MoCA nodes. When an optical network terminal (ONT) is associated with a home or business network that uses MoCA, the ONT may be the MoCA network coordinator. This may be accomplished, for example, by providing the ONT with a MoCA chip. The MoCA chip acts to negotiate the operating channels between the MoCA devices, as well as to parse and handle MoCA format data in control packets or user data traffic.

A plurality of ONTs may be associated with a single optical line terminal (OLT). However, in cases where the ONTs are acting as MoCA network coordinators, each MoCA chip in each ONT can be individually configured and maintained, as each MoCA chip acts as the end point for each of the MoCA networks. This can create a significant expense for customers wishing to have a MoCA network.

### SUMMARY

According to an example aspect of the invention, a method is provided for transmitting MoCA data are a system, apparatus, and computer program that operates in accordance with the method. The method comprises providing MoCA data at a first node on a network, and transmitting the MoCA data in an optical signal to a second node on the network. According to another example aspect of the invention, a system for establishing a MoCA network is provided. The system comprises first and second nodes. MoCA data is communicated between the first and second nodes in at least one optical signal. According to a further example aspect of the invention, an optical network terminal is provided. The optical network terminal includes at least one MoCA chip, and a multiplexer configured to combine a first signal including the MoCA data from the MoCA chip and a second signal into a combined signal. A computer program that operates according to the method also is provided.

### BRIEF DESCRIPTION OF THE DRAWINGS

FIG. 1 is a block diagram of a communications network according to an example embodiment of the invention.

FIG. 2 is a block diagram of an optical line terminal (OLT) coupled to network elements according to an example embodiment of the invention.

FIG. 3 is a block diagram of an optical network terminal (ONT) and associated network elements according to an example embodiment of the invention.

FIG. 4 is a flow chart of an example procedure for establishing and communicating over an extended MoCA network, according to an example embodiment of the invention, from the prospective of an OLT.

FIG. 5 is a flow chart of an example procedure for establishing and communicating over an extended MoCA network, according to an example embodiment of the invention, from the prospective of an ONT.

FIG. 6 is a flow chart of an example procedure for establishing and communicating over an extended MoCA network, according to an example embodiment of the invention, from the prospective of a MoCA node.

FIG. 7 is a flow chart of an example procedure of a MoCA device requesting more power according to an example embodiment of the invention.

FIG. 8 is an architecture diagram of a data processing apparatus according to an example embodiment of the invention.

FIG. 9 is a logical diagram of modules in accordance with an example embodiment of the invention.

FIG. 10 is a graph showing the distribution of information relative to frequency in a PON in accordance with an example embodiment of the invention.

### DETAILED DESCRIPTION

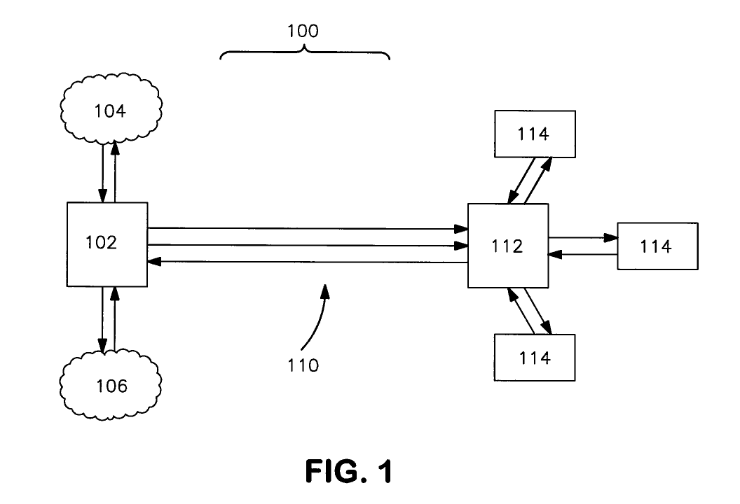

FIG. 1 is a block diagram of a network 100 according to an example embodiment of the invention.

The network 100 may include, for example, a passive optical network architecture (PON). In such a case, the PON may configured as, for example, an asynchronous transfer mode PON (APON), broadband PON (BPON), Gigabit PON (GPON), Ethernet PON (EPON), and 10 Gigabit Ethernet PON (10GEPON). Those skilled in the art will recognize, however, that additional types of PONs also may be used. Moreover, it will be recognized that other types of network architectures may be used for the communication network as well. For simplicity, however, the following description will hereinafter refer to a PON.

The network includes a first node 102, which may be, for example, an optical line terminal (OLT). In such a case, the OLT may form the headend of the PON. Those skilled in the art, however, will recognize that the first node 102 of this example embodiment could be other types of network elements, such as an optical network unit (ONU), remote digital terminal (RDT), a network terminal (NT), and the like. For simplicity, however, the first node 102 will be referred to hereinafter as an OLT.

The OLT includes an interface for receiving a signal from a first information source 104. The first information source 104 may be, for example, a video source. The video source may include, but is not limited to, a cable television (CATV) headend, video server, or any other type of video signal source that provides video transmissions. Moreover, other types of information sources may be provided as the first information source 104. For simplicity, however, hereinafter the signal from the first information source will be referred to as the video signal.

The OLT includes a second interface for connecting to a second information source 106. The second data source 106 may be, for example, an external network. Examples of such a data source include, but are not limited to, a Local Area Network (LAN), or a Wide Area Network (WAN), such as a Public Switched Telephone Network (PSTN) or the Internet, and the like.

For simplicity, hereinafter the signal to and from the second data source 106 will be referred to as including “information,” and, hence, be an “information signal.” The term information signal is not meant to in any way to limit the type of information that may be transmitted in such signals. For example, voice, data, or video information may be all or part of the information in the information signal.

A signal from the first node 102 (e.g., an OLT) is communicated through a FTTx network 110 to a second node 112. As will be described below, the signal may include, for example, a video signal including video data from the first information source 104, information from the second information source 106, as well as additional information. The second node 112 may communicate with a plurality of devices 114 for ultimately processing the information content of the signal received by the second node 112 from the FTTx network 110.

In example embodiments of the invention, the second node 112 may be an optical network terminal (ONT). As those skilled in the art will recognize in view hereof, however, the second node 112 may be other types of network elements, such as optical network units (ONUs), remote digital terminals (RDTs), or the like. Moreover, although FIG. 1 only shows one such node, in example embodiments the FTTx network 110 may link one or more first nodes 102 to multiple second nodes. As noted above, for example, multiple PONs may be associated with an OLT. Thus, in other example embodiments, the multiple PONs may operate between the OLT and multiple nodes. Moreover, as those skilled in the art will recognize in view hereof, in such example embodiments, the network 100 may include additional elements for distributing the PON, such as optical distribution network (ODN) devices, ODN device splitters, and the like.

For simplicity, hereinafter, the second node 112 will be referred to as an ONT. Further, a signal traveling from the OLT to the ONT will be referred to as traveling “downstream,” whereas a signal traveling from the ONT to the OLT will be referred to as traveling “upstream.”

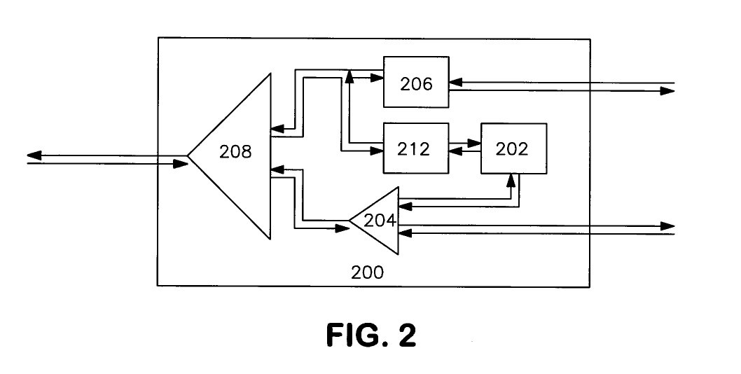

FIG. 2 is a block diagram showing the elements of an OLT 200 for use with a network (such as network 100 that includes a PON in example embodiments). It should be the OLT 200 may include other components as well in addition to those shown in FIG. 2 as are known in the art.

The OLT 200 shown in FIG. 2 includes a MoCA chip 202 for operating an extended MoCA network in conjunction with a network (such as network 100 of FIG. 1). The MoCA chip 202 processes and/or generates data in MoCA format as part of a MoCA network. More specifically, the MoCA chip 202 parses and handles MoCA format data received in an upstream signal (by way of an IWF 218, to be described below), as well as modulates data over specific frequencies to create a signal with MoCA format data for transmission downstream. In example embodiments, the MoCA format data is provided at frequencies above 860 MHz. Further operations of the MoCA chip 202 will be more fully described below.

It should be noted the term “MoCA format signal,” as used herein, means a signal that meets established MoCA standards. Further, “MoCA data,” as used herein, is indicative of information that is sent to and from a MoCA device, i.e., control packets, user data traffic, or the like. Thus, a MoCA format signal may include MoCA data. MoCA data, however, does not have to be provided in a MoCA format signal, and, instead, can be provided in signals of other formats, as described below.

It should further be noted that while the terms “MoCA,” “MoCA data,” and “MoCA format” will be referred to herein, these terms in both this disclosure and the subsequent claims should be construed to encompass Multimedia over Coax Alliance transmissions, data, standards, and the like, as well as subsequently developed equivalents to MoCA which facilitate multimedia over coaxial cable type technologies.

It should also be noted that while the OLT is described herein as including a “MoCA chip”, the OLT may actually include a plurality of such chips, and, thus, may be understood to include a MoCA “chipset.” For example, the OLT may include a MoCA chip for each MoCA network that is to be established between the OLT and a plurality of ONTs. For simplicity, however, the singular term MoCA chip will be used herein to designate the element or elements performing the described operations in conjunction with the extended MoCA network.

A video signal originating from an information source (such as information source 104 shown in FIG. 1) and the MoCA data signal from the MoCA chip 202 are routed in the OLT 200 to a multiplexer 204 (FIG. 2). The multiplexer 204 may be, for example, a wave dimension multiplexer (WDM), although other types of multiplexers may be used as well. The multiplexer 204 receives the video signal and the MoCA data signal, and acts to combine the video and MoCA signals into a combined electrical signal.

In example embodiments of the invention the video signal can be provided in channels in frequencies up to about 860 MHz, and the MoCA format data can operate in frequencies above about 860 MHz. Thus, the multiplexer 204 may maintain the video signal and the MoCA signal and their respective frequencies in the combined signal. That is, the resulting signal can include channels with a video signal at frequencies below about 860 MHz, and MoCA format data above about 860 MHz.

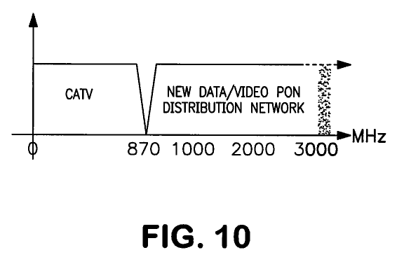

FIG. 10 demonstrates a distribution of information in a PON similar to the above-described example embodiments. In the example embodiment of FIG. 10, lower frequencies are used to provide a cable-television transmission (CATV), whereas the upper frequencies are used to provide other information, for example, MoCA data. Such a distribution may occur, for example, on the 1550 nm signal of a PON.

In still further example embodiments of the invention, the MoCA data can be provided in 50 MHz wide channels above about 860 MHz. As a result, a large amount of bandwidth of the signal is utilized, and, accordingly, a large of amount of data may be provided in the signal.

In example embodiments of the invention, the combined video and MoCA data electrical signal is converted in the OLT 200 to an optical signal. In some example embodiments, the multiplexer 204 may include an electrical-to-optical converter for conversion of the electrical combined signal to the optical combined signal or vice versa in the opposite direction. In other example embodiments, a separate electrical-to-optical converter may be provided to which the combined video and MoCA electrical signal is routed from the multiplexer 204. In still other example embodiments, the below described overlay card 208 may include an electrical-to-optical converter for performing the conversion of the combined electrical signal into the combined optical signal.

In example embodiments of the invention, the video and MoCA data combined optical signal may be at 1550 nm. In such example embodiments, the video and MOCA data in the combined optical signal may still be maintained in the respective frequency channels as they are distributed in the electrical signal. For example, the video signal may be distributed in channels up to about 860 MHz of the 1550 nm signal, and the MOCA data may be distributed in channel in channels above about 860 MHz. As one of ordinary skill in the art will recognize in view of this description, in other example embodiments of the invention, other types of information may be distributed in the channels above or below 860 MHz as well.

The information signal received by the OLT 200 from the second information source 106 is routed in the OLT 200 to a PON card 206, which acts as a generation/termination point for the PON. The PON card 206 includes an electrical-to-optical converter for converting the electrical information signal into an optical data signal or vice versa in the opposite direction. In example embodiments, the optical data signal may be at 1490 nm.

It should be noted that while the OLT 200 of the example embodiment shown in FIG. 2 includes one PON card, the OLT may include multiple PON cards for use with multiple PONs. In such example embodiments, the OLT 200 may act as the headend for multiple PONs operating over the same network. In more specific example embodiments, the OLT 200 may include multiple PON cards for use with multiple PONs for transmission on the network. Moreover, in example embodiments, a single PON may be used in conjunction with multiple ONTs. In a more specific example embodiment, a single PON can be used with 32 ONTs.

Following the generation of the combined video and MoCA optical signal at the optical-to-electrical converter, and the generation of the optical information signal at the PON card 206, the signals are routed to an overlay card 208. In the example embodiment shown in FIG. 2, the overlay card 208 is integrated in the OLT 200. In other example embodiments, however, the overlay card may be an element separate from the OLT 200, and, accordingly, the signals are routed externally from the OLT 200 to the overlay card 208. Further details of such an overlay card and its functions are described in U.S. patent application Ser. No. 11/889,383, the disclosure of which is hereby incorporated by reference herein in its entirety, as if fully set forth herein.

The overlay card 208, according to an example embodiment of the invention, includes a multiplexer/demultiplexer which receives the combined video and MoCA optical signal from the multiplexer 204 and the information signal from the PON card 206. The multiplexer of the overlay card 208 transparently overlays, or combines, the optical signals. As a result, a combined signal that includes the video, MoCA, and information signals is produced and outputted by the overlay card 208 in optical form. In example embodiments, the combined video, MoCA and information signal may include the video and MoCA data at 1550 nm, and the information signal (originating from an information source such as second information source 106 of FIG. 1) at 1490 nm. However, other wavelengths can be used for any or all of the transmissions. As one skilled in the art will recognize upon reading this description and viewing FIG. 2, communication can be provided bi-directionally in the device of FIG. 2, although, for convenience, this description is described in the context of communications received from sources (for example, information sources 104 and 106 of FIG. 1) being provided toward the overlay card 208 in the OLT 200.

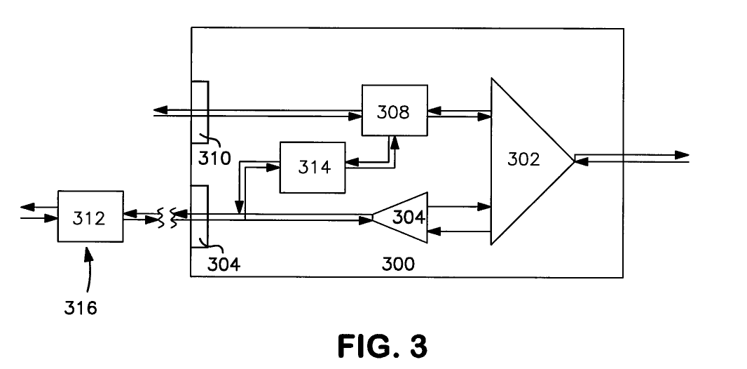

FIG. 3 is a block diagram of the elements of an ONT 300 for use with a network (for example, network 100 of FIG. 1) in example embodiments of the invention. It should be noted that ONT 300 may also include further elements as are known in the art, although for convenience, they are not shown herein.

It should also be noted that while the ONT 300 is described herein as being associated with a single home network 316, the ONT 300 in fact may be associated with a plurality of home networks. Moreover, the ONT 300 may be associated with different types of networks other than “home” networks. For example, the ONT may be associated with a business or an office network, or other types of networks.

In the example embodiment of the invention depicted in FIG. 3, the combined MoCA, video, and information signal (from, e.g., OLT 200) is received at an interface of the ONT 300 and routed to a triplexer 302. The triplexer 302 accepts the frequency spectrum from the combined signal, and acts to “demultiplex” at least part of the spectrum into different signals. The triplexer 302 also includes an optical-to-electrical converter, which converts the MoCA, video, and information signals into electrical signals. As those in the skilled in the art will recognize in view of this description, the MoCA, video, and information signals will still each have the same frequency distributions as were present in the combined optical signal received at the ONT 300. Thus, as in the example embodiments discussed above, the electrical video signal is in channels up to about 860 MHz and the electrical MoCA data is in channels above about 860 MHz. Moreover, the MoCA data will still be in MoCA format.

In some example embodiments of the invention, the triplexer 302 may be configured to only allow certain parts of the combined MoCA, video and information signal to pass through for further processing and uploading to the home network 316. For example, when the video transmission of the combined optical signal is a CATV transmission, a service provider may not want the CATV to be received by a customer who has not subscribed to the CATV service to receive the CATV transmission. In such a case, a spectrum pass-band (not shown) within the triplexer 302 is configured to allow the frequencies carrying the MoCA data and information signals be routed out of the triplexer, while blocking the frequencies of the CATV transmission. Such a configuration may be, for example, configured at the PON's element management system (EMS) (not shown in FIG. 3) and sent down to the ONT 300 via the operations management channel (OMCI) of the PON. The ONT 300 may store information about the spectrum pass-band, for example, in its non-volatile RAM (NVRAM) (not shown in FIG. 3).

The electrical MoCA format signal and the electrical video signal are routed from the triplexer 302 to a diplexer 304. In example embodiments of the invention, the diplexer 304 is a wave dimension multiplexer/demultiplexer. The diplexer functions to recombine the MoCA format signal and the video signal into a combined electrical signal for transmission towards the home network 316.

The combined MoCA format signal and video signal is routed from diplexer 304 to a port 306 for transmission on the home network 316. In example embodiments of the invention, the port 306 is a coaxial cable port, connected to a coaxial cable for receiving the combined MoCA format and video signal.

As one skilled in the art will recognized upon reading this description and viewing FIG. 3, the OLT 300 supports bi-directional communications, i.e., signals can travel in an opposite direction through the OLT 300 than that already described herein, and can be processed accordingly.

In example embodiments of the invention, the home network 316 may comprise a plurality of MoCA devices (such as devices 114 of FIG. 1), such as televisions, set-top-boxes (STBs), digital video recorders (DVRs), computers, gaming systems, and the like. In such a case, routing information included in the MoCA format signal routes the signal to the appropriate MoCA device corresponding thereto. Such routing information may be provided by a MoCA transceiver 312 (described below). The video signal can also be routed to appropriate devices for further processing, i.e., a television, video disk player, or the like.

In example embodiments of the invention, the information signal that was carried on the 1490 nm optical signal may be routed from the triplexer 302 to an Ethernet controller 308 of ONT 300. The Ethernet controller 308 in turn may be associated with an RJ45 Data Port 310, and thereby be connected by an Ethernet cable to devices in the home network 316. Thus, as an example, Internet data carried on the 1490 nm optical signal may be routed to a computer on the home network 316 or other data processing device. In some example embodiments of the invention, the information may be routed to the same devices as the MoCA format signal and the video signal, although this is not represented in FIG. 3. In other embodiments, the information may be routed to other home network devices (not shown in FIG. 3).

The ONT 300 also may be configured to receive signals from the home network 316 for routing upstream to the OLT as pointed out above.

In order to facilitate the upstream routing of MoCA data, a MoCA transceiver 312 may be associated with the ONT 300. In example embodiments, the MoCA transceiver 312 may be a MoCA sniffer/snooper that provides a bridge between the MoCA devices 114 of the home network 316 and the ONT 300 after negotiating communications with the MoCA devices, as will be more fully described below.

In the example embodiment shown in FIG. 3, the MoCA transceiver 312 is shown as being external to the ONT 300, and can be connected to the ONT 300 by a coaxial cable at coaxial port 306. In alternative example embodiments, the MoCA transceiver 312 may be positioned within the ONT 300, and thereby receive/transmit a MoCA format signal from/to the MoCA devices 114 via a coaxial cable connected to the coaxial port 306.

The MoCA format signal received from the home network 316 is routed from the coaxial cable port 306 to an Interworking Function (IWF) 314 of the ONT. The IWF 314 acts as a converter for converting the MoCA format signal into an Ethernet signal containing the MoCA data. Such a conversion can be performed according to one or more existing or later developed Ethernet standards. As such, the Ethernet signal containing the MoCA data can be forwarded to the Ethernet controller 308 of the ONT 300 by way of the IWF 314.

In alternative example embodiments of the invention, each MoCA device 114 itself may convert upstream traffic to another format before routing to the ONT 300. For example, the MoCA device may route the MoCA data in Ethernet packets to Ethernet port 310, via a virtual local area network (VLAN), via Home Phoneline Networking Alliance (HPNA) traffic, or wirelessly by WiFi ® to a WiFi ® transceiver (not shown) in the ONT 300. In such example embodiments, a transceiver 312 is not necessary for communication between the MoCA device 314 and the ONT 300.

In example embodiments of the invention, the MoCA control data may be added at the Ethernet controller 308 to the OMCI channel that has been negotiated on the upstream optical signal. In further example embodiments of the invention, some or all of the MoCA data may be added as part of the VLAN between the ONT 300 and an OLT (for example, the OLT 200 of FIG. 2). In still further example embodiments of the invention, other communication protocols or procedures may be used to transport the MoCA data from the ONT 300 and the OLT. For example, the MoCA data could be part of a GPON Encapsulation Mode (GEM) flow between the ONT 300 and OLT. Moreover, the MoCA data could be provided on multiple channels between the ONT 300 and the OLT. For example, MoCA control packets could be sent via the OMCI channel, while MoCA user traffic could be sent over an Ethernet frame encapsulated in a GEM port, or the MoCA user traffic could be encapsulated in a VLAN, and then encapsulated in a GEM port. In all these methods, the MoCA data need not be in MoCA format in that it will conform to MoCA standards and protocols, e.g., it need not be in a certain MoCA frequency range. The content of the MoCA data, e.g., the user data traffic or control packets, however, is routed from the ONT 300 upstream to another node (for example, the OLT 200 of FIG. 2). As described below, the MoCA data may be reconverted to MoCA format at the OLT, as described below.

When the MoCA data converted to Ethernet packets at IWF 314 is to be routed upstream from the ONT 300, the MoCA data, as well as an upstream data signal from an external network, are routed from Ethernet controller 308 to the triplexer 302. To the upstream traveling signal, the triplexer 302 acts as an electrical-to-optical converter (in addition to multiplexing any such signal with those received from the multiplexer 304 to form a combined upstream signal), converting the electrical signal that includes the MoCA data into an optical signal. The optical signal containing at least the MoCA data may then be routed upstream through the FTTx network 110 to the another node 102 (such as the OLT 200 of FIG. 2). In example embodiments, the upstream optical signal that includes the MoCA data may be at 1310 nm. Thus, as is apparent from this description, bi-directional communication which includes at least MoCA data can be established between two nodes of an optical network, such as between OLT 200 and ONT 300.

Referring again to FIG. 2, the overlay card 208 of the OLT 200 coverts the combined upstream optical signal received from an ONT (such as the ONT 300 of FIG. 3) via the FTTx network 110 into an electrical signal. The MoCA data in the electrical signal is routed to an IWF 212 of the OLT. The IWF 212 functions to reconvert the MoCA data in the electrical signal back into MoCA format, for example, through conversion techniques implemented at the software level. The MoCA data can then be routed to the MoCA chip 202 for further processing, as described above.

Thus, an extended MoCA network is established between the MoCA nodes, or, more specifically, between MoCA devices (such as devices 114 of FIG. 1) on a network (such as home network 316 of FIG. 3) and the OLT (such as the OLT 200 of FIG. 2) by way of ONT (such as the ONT 300 of FIG. 3). The OLT thereby may function as the MoCA network coordinator, acting to, among other things, negotiate communications with all of the MoCA devices admitted to the MoCA network. As the OLT may be associated with multiple ONTs, the OLT can be a single centralized point for network coordination with a plurality of MoCA networks.

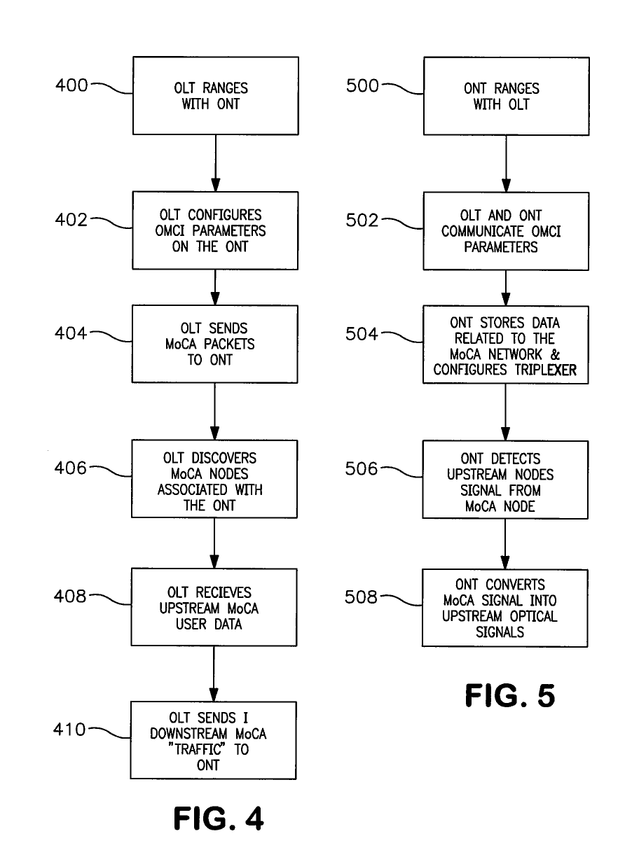

FIGS. 4-6 are flow charts detailing procedures according to example embodiments of an OLT, ONT, and MoCA node establishing and communicating over an extended MoCA network. It should be noted that while these procedures describe the establishment of a PON between an OLT and an ONT, one or more OLTs may establish multiple PONs with one or more ONTs, as is described above.

Referring to FIG. 4, at block 400 the OLT (e.g., 102) ranges an ONT (e.g., 112) to begin establishing a PON. At block 402, the OLT configures OMCI parameters on the ONT (e.g., 112). The OMCI parameters may be pre-configured using the EMS. The OMCI parameters may contain provisioning information, such as a frequency spectrum, which the ONT should allow to be sent through to the connected network.

After establishing communication with the ONT, at block 404 the OLT sends MoCA data packets downstream to the ONT, for example, on an 1550 nm signal. The MoCA signal is preconfigured and may be based on service provider preferences.

At block 406, the OLT next discovers MoCA devices or nodes (e.g., 114) associated with the ONT to which the PON is established. For example, the OLT may receive MoCA beacon packets in reply to the MoCA data packets from MoCA devices or nodes via at least one ONT and FTTX network, as described above. During the discovery procedure, the OLT receives upstream PHY layer MoCA messages from the ONT, for example, via the 1310 nm signal as described above. The OLT processes these messages and may perform maintenance to the MoCA devices based on requests received from the new MoCA devices being discovered. For example, if one or more of the MoCA devices requests more power, the OLT may adjust the power to the MoCA devices, as will be more fully described below.

After establishing communication with the MoCA devices, and, hence, an extended MoCA network, at block 408 the OLT receives upstream MoCA user data from the MoCA devices. In an example embodiment of the invention, the upstream MoCA data includes a request from a MoCA device to transmit or receive a number of packets of information. More specifically, for example, a MoCA device may send a user data request to transmit or receive a number of packets of specific video, voice, or data upstream from the OLT to or from an external network (e.g., 104 or 106), as described above.

The OLT processes the request, and, in turn, at block 410 the OLT sends the requested user data traffic downstream on the negotiated MoCA channel which is part of the 1550 nm signal to the ONT, and, ultimately, to the MoCA device that generated the request. For example, in response to a request from a MoCA device to send a number of packets of information, the OLT sends an authorization downstream on the MoCA channel to the MoCA device to send the packets of information.

Thus, according to this example procedure, the OLT may establish an extended MoCA network in conjunction with MoCA devices and an ONT. Further, the OLT may act as a network controller for the MoCA network by receiving and distributing MoCA information to the MoCA devices. As will be apparent to one of ordinary skill in the art in view of this description, the extended MoCA network provides a transparency to other protocols, thereby simplifying the communication of information with other protocols between, for example, the MoCA devices, OLT, and ONT; between the MoCA devices and other information sources (e.g., 104 and 106); and between the MoCA devices themselves.

It should be noted that additional decision blocks may be provided to the procedure shown in FIG. 4. For example, a decision block may be provided for discovering new MoCA nodes after block 410, wherein if a new node is discovered the procedure is returned to block 406. As another example, a decision block may be provided for discovering a new ONT, wherein if a new ONT is discovered the procedure is returned to block 400 after block 410.

FIG. 5 details a procedure of establishing an extended MoCA network between a MoCA node and an OLT from the prospective of an ONT according to an example embodiment of the invention.

At block 500, the ONT (e.g., 112) first ranges with the OLT (e.g., 102), and, at block 502 configures OMCI parameters in conjunction with the OLT via upstream and downstream optical signals. The ONT then, at block 504, stores MoCA network configuration data received from the OLT. Also at block 504, the ONT may configure its triplexer (e.g., 302) based on such information received from the EMS of the OLT, as described above.

At block 506, the ONT then detects a MoCA upstream signal received from a MoCA node (e.g., 114), and, at block 508 coverts the upstream signal to an optical signal for inclusion on the 1310 nm upstream signal to the OLT, as described above.

In an alternative embodiment of the invention, the ONT may not have MoCA integrated in its components. For example, a MoCA transceiver could act to receive and transmit the MoCA data from and to the OLT in a similar manner as described above. In such a case, the ONT is completely transparent to the MoCA network. Thus, in such an example embodiment of the invention, the ONT treats the MoCA data in the downstream signal from the OLT the same as the other information on the downstream signal, and the MoCA data is accordingly routed, for example, to a MoCA transceiver on the home network.

Referring once again to the example embodiment of FIG. 5, once the MoCA network has been established in conjunction with the ONT, the ONT may perform statistics, status, performance monitoring, alarm processing, and the like for the MoCA network. The ONT may store such data locally (such as in RAM or NVRAM). The ONT may also send such data to the OLT, for example, via the OMCI channel of the upstream signal. In such a case, the OLT could perform management decisions based on the information received from the ONT.

It should be noted that additional decision blocks may be provided to the procedure shown in FIG. 5. For example, a decision block may be provided for detecting a new MoCA node, wherein, if a new node is discovered, the procedure is returned to block 506.

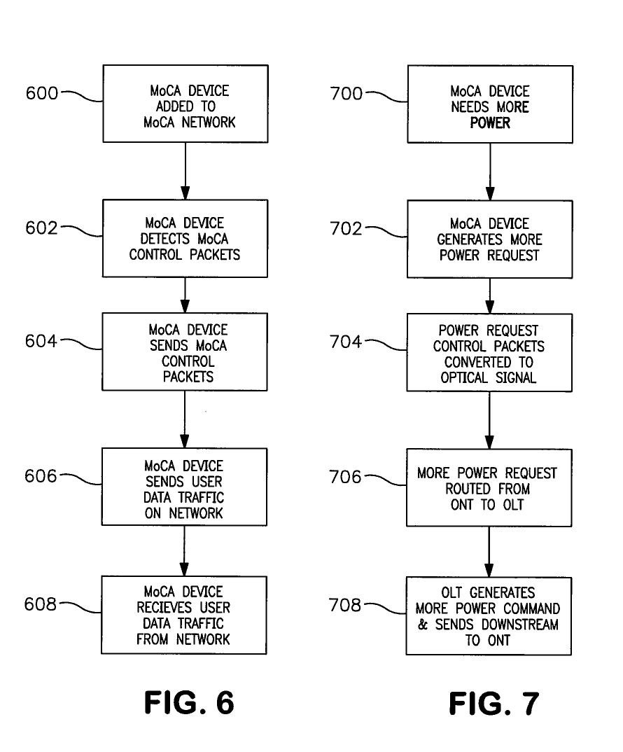

FIG. 6 details a procedure of establishing an extended MoCA network between a MoCA node and an OLT from the prospective of a MoCA node according to an example embodiment of the invention.

The procedure begins at block 600 when a MoCA node (e.g., 114), such as a MoCA home device, becomes associated to the MoCA network, for example, upon establishing communication with an OLT (e.g., 112) according to the above-described procedure. At block 602, the MoCA node detects MoCA control packets originating from the MoCA chip in the OLT, as described above. The MoCA node responds to the MoCA control packets from the OLT by sending its own control packets to the OLT via the ONT, in order to negotiate the channel parameters, as indicated at block 604. For example, a specific channel on the MoCA network may have been established to deliver specific information, in which case the MoCA node, as part of the channel negotiating process, may be configured to receive and/or transmit the channel. Once the MoCA node is associated with the MoCA network, the MoCA node can send MoCA user data traffic upstream via the ONT (e.g., 112) to the OLT along the 1310 optical signal, as shown in block 606. Further, at block 608 the MoCA node can receive user packets downstream via the MoCA channel from the OLT via the 1550 optical signal, as described above.

FIG. 7 details an example procedure in which a MoCA device (e.g., 114) sends a MoCA control packet on the MoCA network to the MoCA chip in the OLT, specifically, wherein the MoCA device requests more power, that is, a stronger signal. In this example embodiment, at block 700 a MoCA device determines that it needs to receive more power from the network to which it is connected in order to achieve, for example, a predetermined data rate. The MoCA device, therefore, at block 702, generates a request for more power in the form of a MoCA format control packet.

In this example embodiment, at block 704, MoCA power request control packets generated at block 702 are converted to optical format at the ONT (e.g., 112). As described above, the format conversion may be done at a MoCA node (e.g., 114), or at the ONT (e.g., 112) itself, and the control packets may be added to different channels or transmissions (i.e., OMCI channel, VLAN, GEM flow, etc). The ONT then at block 706 routes the optical signal with the more power request through an FTTx network to an OLT. The OLT, and, more specifically, the MoCA chip in the OLT, receives the MoCA message requesting more power. A command is thereby generated by the chip to add power in response to the request, and in turn the command is sent by the OLT downstream to the ONT at block 708. In such example embodiments, the downstream message from the OLT to the ONT may be sent via the OMCI channel, which may be part of a 1490 nm transmission, or through another suitable channel. The command to adjust the power can be executed, for example, by the power function on the triplexer (e.g., 302) of the ONT to adjust the power level provided at the coxial interface (e.g., 306), based on the command. Other devices in the ONT may adjust the power as well.

In another alternative embodiment to that shown in FIG. 7, the ONT may handle all MoCA control or management messages itself, without forwarding the messages upstream to the OLT. In such a case, the ONT may snoop and process the MoCA control or management messages, such as a request for more power, and then respond accordingly, such as by adjusting the power, as described above.

In various alternative embodiments of the invention wherein the power to a MoCA device is adjusted, different procedures may be used to effect the power adjustment. For example, the ONT could increase the AGC power for a MoCA interface (while considering how modifying the AGC may impact the overall spectrum).

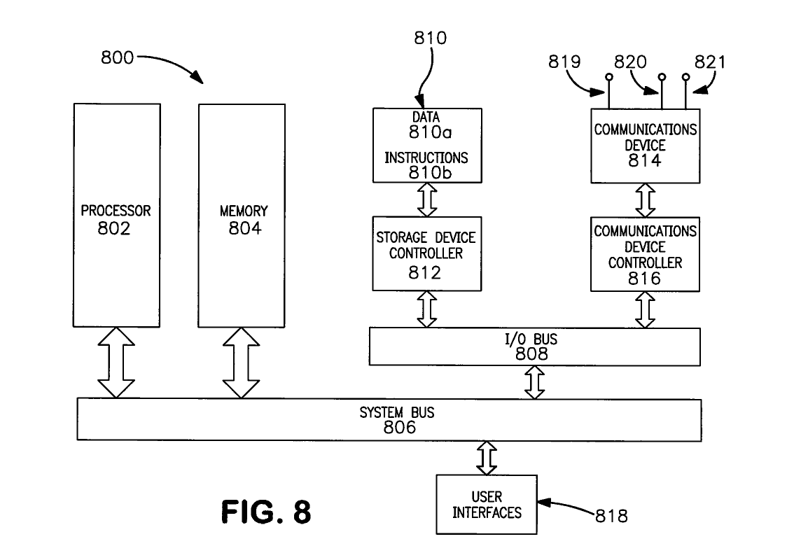

FIG. 8 is an architecture diagram of an example data processing system 800 which, according to an example embodiment of the invention, can form individual ones of the components of OLT 200 (FIG. 2) or ONT 300 (FIG. 3) EMS, and/or other nodes 114 (FIG. 1). Data processing system 800 includes a processor 802 coupled to a memory 804 via system bus 806. Processor 802 is also coupled to external Input/Output (I/O) devices (not shown) via the system bus 806 and an I/O bus 808, and at least one input/output user interface 818. Processor 802 may be further coupled to a communications device 814 via a communications device controller 816 coupled to the I/O bus 808. Processor 802 uses the communications device 814 to communicate with a network, such as, for example, the network 100 or the home network 316, as shown in FIGS. 1 and 3 respectively. In the case of at least the ONT 300, device 814 has data port 819 operably coupled to a network (e.g., a PON) for sending and receiving data, and services data ports 820 and 821, which may be, for example, the coaxial cable port 306 (FIG. 3) and Ethernet port 310 (FIG. 3) for sending and receiving Ethernet, video and MoCA data, as described above. It is noted, however, the device 814 may also have one or more additional input and output ports. A storage device 810 having a computer-readable medium is coupled to the processor 802 via a storage device controller 812 and the I/O bus 808 and the system bus 806. The storage device 810 is used by the processor 802 and controller 812 to store and read/write data 810a, and to store program instructions 810b used to implement the procedures described above in connection with FIGS. 4-7. The storage device 810 also stores various routines and operating programs (e.g., Microsoft Windows, UNIX/LINUX, or OS/2) that are used by the processor 802 for controlling the overall operation of the system 800. At least one of the programs (e.g., Microsoft Winsock) stored in storage device 810 can adhere to TCP/IP protocols (i.e., includes a TCP/IP stack), for implementing a known method for connecting to the Internet or another network.

In operation, processor 802 loads the program instructions 810b from the storage device 810 into the memory 804. Processor 802 then executes the loaded program instructions 810b to perform any of the example methods described above, for operating the system 800.

In example embodiments, the instructions 810b stored in the storage device 810 include instructions which, when executed by the processor 802, enable the IWFs 212 and 314 (FIGS. 2 and 3, respectively) of the OLT 200 (FIG. 2) and ONT 300 (FIG. 3) to perform the conversions of the MoCA data described above. Further, in an example embodiment of the invention, the instructions 810b stored in the storage device 810 include instructions which, when executed by the processor 802, result in more power being sent to a MoCA device originating a more power request, as described above in conjunction with FIG. 7.

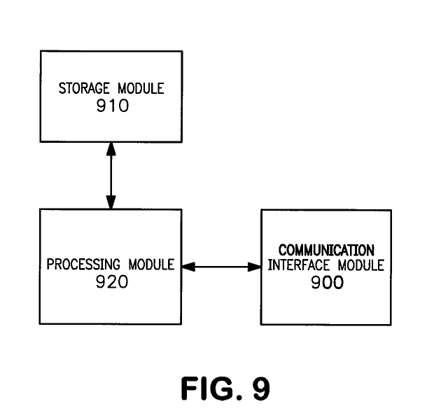

FIG. 9 is a logical diagram of modules in accordance with an example embodiment of the invention. The modules may be of a data processing system or device 800, which, according to an example embodiment of the invention, can form individual ones of the components of OLT 200, ONT 300, EMS and/or other types of nodes 114. The modules may be implemented using hardcoded computational modules or other types of circuitry, or a combination of software and circuitry modules. The modules may perform processing according to the methods described above.

Communication interface module 900 controls communication device 814 by processing interface commands. Interface commands may be, for example, commands to send data, commands to communicatively couple with another device, or any other suitable type of interface command.

Storage device module 910 stores and retrieves data in response to requests from processing module 920.

By virtue of the example methods, system, apparatus, and computer program described herein, a MoCA standard (or other multimedia-over-coaxial-cable technology) network can be created in conjunction with an optical network, such as a PON. Thus, a single OLT headend of the optical network may act as a MoCA network controller as the centralized point for one or a plurality of MoCA networks associated with one or a plurality of ONTs connected to the OLT, or plural OLTs. Further, a large spectrum of the optical signal of the PON may be utilized, thereby allowing large amounts of data, including MoCA control packets and user traffic, to be communicated on the network. All of the foregoing can be accomplished without the need for additional equipment at the ONT end of the PON, thereby minimizing additional costs.

Although this invention has been described in certain specific example embodiments, many additional modifications and variations would be apparent to those skilled in the art. It is therefore to be understood that this invention may be practiced otherwise than as specifically described. For example, an example embodiment of the invention may use a multimedia-over-cable technology other than MoCA. An example embodiment of the invention may be used in any PON such as APON, BPON, GPON, EPON or 10GEPON. Thus, the example embodiments of the invention should be considered in all respects as illustrative and not restrictive, the scope of the invention to be determined by any claims supportable by this application and the claims' equivalents rather than the foregoing description.

FIGS. 4-6 are flow charts illustrating methods according to example embodiments of the invention. The techniques illustrated in these figures may be performed sequentially, in parallel or in an order other than that which is described. It should be appreciated that not all of the techniques described are required to be performed, that additional techniques may be added, and that some of the illustrated techniques may be substituted with other techniques.

Software embodiments of the invention may be provided as a computer program product, or software, that may include an article of manufacture on a machine accessible or computer-readable medium (memory) having instructions. The instructions on the machine accessible or computer-readable medium may be used to program a computer system or other electronic device. The computer-readable medium may include, but is not limited to, floppy diskettes, optical disks, CD-ROMs, and magneto-optical disks or other types of media/computer-readable medium suitable for storing or transmitting electronic instructions. The techniques described herein are not limited to any particular software configuration. They may find applicability in any computing or processing environment. The terms “machine accessible medium,” “memory,” or “computer-readable medium” used herein (if at all) shall include any medium that is capable of storing, encoding, or transmitting a sequence of instructions or data for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other embodiments, functions performed by software can instead be performed by hardcoded modules, and thus the invention is not limited only for use with stored software programs.

In addition, it should be understood that the figures illustrated in the attachments, which highlight the functionality and advantages of the example aspects of the present invention, are presented for example purposes only. The architecture of the example aspects of the present invention is sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the processes recited in the claims need not be performed in the order presented.

What is claimed is:

1. A method of transmitting MoCA data, comprising:
providing MoCA data at a first node on a network; and
transmitting the MoCA data in an optical signal to a second node on the network.

2. A method according to claim 1, wherein the first node and second node are selected from the group consisting of an optical line terminal and an optical network terminal.

3. A method according to claim 1, further comprising transmitting a video signal in frequency bands in a first frequency range in the optical signal,
wherein the MoCA data is transmitted in frequency bands in a second frequency range in the optical signal.

4. A method according to claim 3, wherein the first frequency range is from 0 to about 860 MHz and the second frequency range is above about 860 MHz.

5. A method according to claim 4, wherein the optical signal is at 1550 nm.

6. A method according to claim 1, wherein the MoCA data is transmitted from the first node to the second node in an optical signal at 1550 nm.

7. A method according to claim 1, wherein the MoCA data is transmitted from the first node to the second node in an optical signal at 1310 nm.

8. A method according to claim 1, wherein the MoCA data is transmitted from the first node to the second node, and further comprising transmitting MoCA data from the second node to the first node.

9. A method according to claim 1, wherein the MoCA data is transmitted in at least one of the group consisting of an OMCI channel, a VLAN, and a GEM flow.

10. A method according to claim 1, further comprising providing the MoCA data from a MoCA device to the first node.

11. A system for establishing a MoCA network, comprising:
a first node; and
a second node,
wherein MoCA data is communicated between the first and second nodes in at least one optical signal.

12. A system according to claim 11, wherein the first node is an optical line terminal and the second network node is an optical network terminal.

13. A system according to claim 12, wherein the optical network terminal is associated with at least one MoCA device.

14. A system according to claim 11, wherein a video signal is communicated in frequency bands in a first frequency range in the optical signal, and the MoCA data is communicated in frequency bands in a second frequency range in the optical signal.

15. A system according to claim 14, wherein the first frequency range is from 0 to about 860 MHz and the second frequency range is above about 860 MHz.

16. A system according to claim 15, wherein the optical is at 1550 nm.

17. A system according to claim 15, wherein the second node is configured to block the video signal and allow the MoCA data to pass through to further network elements.

18. A system according to claim 11, wherein the MoCA data is communicated in an optical signal at 1550 nm.

19. A system according to claim 11, wherein the MoCA data is communicated in an optical signal at 1310 nm.

20. A system according to claim 11, wherein the MoCA data is communicated in at least one of the group consisting of an OMCI channel, a VLAN, and a GEM flow.

21. A system according to claim 11, further including:
a MoCA receiver associated with the second node and a MoCA device,
wherein the MoCA receiver communicates with the MoCA device, and routes MoCA data to the second node.

22. An optical network terminal, comprising
at least one MoCA chip; and
a multiplexer configured to combine a first signal including MoCA data from the MoCA chip and a second signal into a combined signal.

23. An optical network terminal according to claim 22, further including an interface configured to receive MoCA data and provide the MoCA data to the MoCA chip.

24. An optical network terminal according to claim 22, further including an overlay card configured to combine the combined signal and a third signal.

25. An optical network terminal according to claim 22, wherein the MoCA data is in MoCA format.

26. An optical network terminal according to claim 22, wherein the at least one MoCA chip includes a MoCA chipset.

27. A method of operating an optical network, comprising:
communicating the optical signal in the optical network,
wherein the optical signal includes a MoCA transmission in a first frequency range.

28. A method according to claim 27, wherein the first frequency range is above about 860 MHz.

29. A method according to claim 27, wherein the MoCA data is in MoCA format.

30. A method according to claim 27, wherein the optical signal further includes a video signal.

31. A method according to claim 30, wherein the video signal is in a second frequency range.

32. A method according to claim 31, wherein the first frequency range is above about 860 MHz and the second frequency range is from 0 to about 860 MHz.
